(19) United States
(12) Patent Application Publication
(10) Pub. No.: US 2005/0222869 A1
(43) Pub. Date: Oct. 6, 2005

(54) Double blind evaluation method for malpractice claims

(76) Inventors: Bruce B. Bealke, Valley Village, CA (US); Lawrence W. Shea II, La Jolla, CA (US)

Correspondence Address: ROBERT R. THORNTON, 3264 MEADOWLARK LANE, CARLSBAD, CA, 92008-2024, US

(21) Appl. No.: 10/820,193

(22) Filed: Apr. 6, 2004

(51) Int. Cl. G06F 17/60

(52) U.S. Cl. 705/2

(57) ABSTRACT

Eliminating actual and potential bias from a malpractice claim evaluation process utilizes a double blind evaluation method, which includes the steps of retention by an entity having a direct or indirect interest in the claim of a neutral third party to obtain an independent evaluation of the claim, acquisition by the third party of facts relating to the claim which are sufficient to permit an independent objective evaluation of the claim, retention by the third party of a qualified independent expert to perform the claim evaluation, redaction from the sufficient facts of all facts which would permit the expert to identify any party involved or having an interest in the claim, submission by the third party of the sufficient facts after redaction to the expert in order to permit the expert to make an independent objective evaluation of the claim, preparation by the expert of a written independent objective evaluation of the claim, submission of the written claim evaluation by the expert to the third party, redaction from the written claim evaluation of any information which would permit identification the expert, and submission of the evaluation after redaction to the entity retaining the third party.

### BACKGROUND OF THE INVENTION

1. Field of Invention

This invention generally relates to a method to be used to objectively evaluate malpractice or similar claims as to the merit of claim, and, more particularly, to the elimination of actual or perceived bias from such evaluations by using a “double blind” method for the evaluation.

2. Description of the Prior Art

Under the present system for evaluating malpractice claims or allegations (hereinafter, jointly and severally, “claims”), consultants having expertise in the appropriate field (hereinafter, “experts”), receive requests for evaluation of claims made by claimants relating to various forms of alleged professional malpractice. Such a request is usually received from an insurance carrier (hereinafter, “carrier”) or from an attorney for the carrier or for the claimant, rather than the claimant personally. The information typically provided to the expert includes details about a person or persons and/or one or more business entities in addition to specifics as to facts asserted to give rise to the claim, as well as information about the possible defenses to or arguments against or in mitigation of the claim.

These experts typically would like to maintain good relationships with the carriers or attorneys who retain them. Consequently, such experts are often viewed as likely to provide an opinion needed to support or defeat or diminish the value of the claim, that is, support the position of the entity retaining the expert, rather than providing an independent objective evaluation. The experts often hope to rely on repeat business from those who retain the expert. In the case of medical malpractice claims, for example, an expert often knows a physician against whom a claim is made. The desire to maintain and foster these relationships creates an apparent potential basis toward giving an opinion favorable to the retaining entity, rather than a truly objective evaluation.

In order to keep existing good business relationships and continue to develop a book of business, an expert may, either intentionally or inadvertently, skew the evaluation in favor of the retaining entity. Even if such skewing does not actually occur, the possibility of its occurrence tends to lessen the utility of the evaluation, particularly as a settlement tool as indicative of a truly independent evaluation of the merits of the claim and monetary damages based thereon. Due to this perceived potential, if not actual, bias in the current system, often claims are not settled or litigated based on any reasonably objective evaluation criteria, resulting in higher litigation and insurance costs. The method of the present invention overcomes these deficiencies with respect to the systems currently used to provide such evaluations.

### SUMMARY OF THE INVENTION

Eliminating actual and potential bias from a malpractice claim evaluation process according to the present invention utilizes a double blind evaluation method for a malpractice claim, which includes the steps of retention by an entity having a direct or indirect interest in the claim of a neutral third party to obtain an independent objective evaluation of the claim, acquisition by the third party of facts relating to the claim which are sufficient to permit an independent objective evaluation of the claim, retention by the third party of a qualified independent expert to perform the claim evaluation, redaction from the sufficient facts of all facts which would permit the expert to identify any party involved or having an interest in the claim, submission by the third party of the sufficient facts after redaction to the expert in order to permit the expert to make an independent objective evaluation of the claim, preparation by the expert of a written independent objective evaluation of the claim, submission of the written claim evaluation by the expert to the third party, redaction from the written claim evaluation of any information which would permit identification the expert, and submission of the redacted evaluation to the entity retaining the third party.

### BRIEF DESCRIPTION OF THE DRAWING

FIG.1 is a block diagram illustrating the steps of the presently preferred method for the double blind evaluation for malpractice claims according to the present invention.

### DETAILED DESCRIPTION OF THE INVENTION

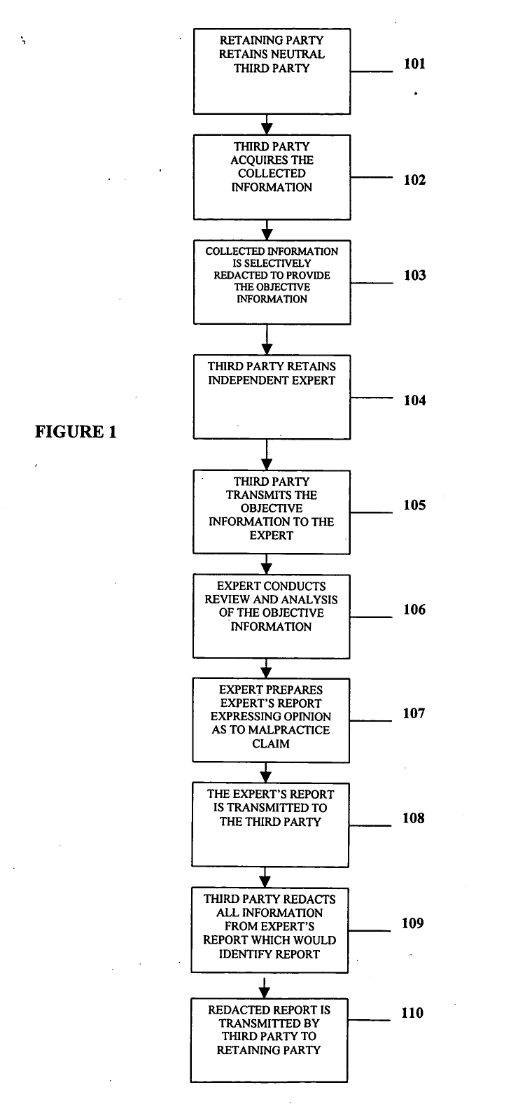

In the practice of the present invention according to the presently preferred embodiment shown for illustrative purposes, and not by way of limitation, in FIG. 1, an entity having an interest in a malpractice claim, such as an insurance carrier or its representative or a claimant or its representative, or an entity conducting or attempting a judicial or quasi-judicial determination of the claim (hereinafter “retaining party”) retains a neutral third party to provide it with an independent objective evaluation of the claim (Block 101).

The neutral third party directly gathers, or otherwise acquires, objective, confidential information relating to the claim, such as:
facts and documents that relate to the claim (e.g. medical records and/or business records, etc., as may be appropriate for the particular type of claim);
background information about the party asserting the claim and the party against whom the claim is asserted, such as resumes, curriculum vitae, educational history, professional training, employment history, etc., as appropriate; and
facts about the party's peer group in the same geographic area, if appropriate (hereinafter, collectively, the “collected information”). (Block 102).

After the collected information has been acquired by the third party, all materials which would identify the particular individuals or businesses having any direct or indirect interest in the claim or its outcome are redacted by the third party from the collected information, leaving the “objective information.” (Block 103).

The neutral third party retains a qualified independent expert to provide an expert opinion on the issues involved. (Block 104). The expert has board certifications, professional registrations, and/or other experience and/or training which constitute sufficient qualification to render a competent expert opinion with respect to one or more of the issues involved in the claim.

The neutral third party transmits the objective information to the expert. (Block 105). None of the objective information transmitted to the expert reveals in any way the identity of the person or entity that retained the neutral third party, as well as not revealing the identity of any persons or entities having an interest in the claim or its outcome.

The expert conducts such review and/or analysis of the objective information and performs such investigations, if any, as to the objective information as the expert deems necessary and appropriate in order to render an independent objective evaluation of the claim as to malpractice. (Block 106).

After completing this review and analysis, the expert prepares a written report of findings and conclusions, including, when appropriate, an evaluation of the claim's worth in monetary terms. This written report includes references to supporting literature and other documentation where appropriate (the “expert's report”) (Block 107).

The expert then causes the expert's report is then transmitted to the third party. (Block 108).

Upon receipt of the expert's report, the neutral third party redacts all information from the expert's report which would identify the expert (the “redacted report). (Block 109).

The redacted report is then transmitted by the neutral third party to the retaining party or to such other person or entity as the retaining party may direct to assist in evaluating the claim for malpractice. (Block 110).

Payment for the expert's services is made by the neutral third party. The neutral third party bills the retaining person or entity for the expert's services, either directly by submitting a redacted version of the expert's bill, or, preferably by billing the retaining person or entity for the expert's fee as an expense. Thus, the retaining party never is provided with any identification of the expert, or the means to make such an identification.

At all times the neutral third party keeps information about the parties in the strictest confidence. Consequently, throughout the practice of the present invention, none of the parties having an interest in the claim knows the identity of any adverse party. In addition, the expert never is provided with the ultimate outcome or the resolution of the claim, thereby remove any potential for bias by that expert in evaluating future similar claims when utilizing the double blind method of the present invention.

The double blind evaluation method of the present invention removes bias from the evaluation process, since the expert has no active interest in the outcome of the matter being evaluated. Thus, the parties having an interest in the claim are more likely to accept the independent, unbiased, objective opinion regarding the merits of the claim provided by the practice of the present invention. Such acceptance can facilitate earlier settlements. Settling valid claims early through the practice of the present invention reduces the cost and burden on the legal system and the cost of litigation to the parties. The practice of the present invention also reduces the overall cost of resolving malpractice claims incurred by insurance carriers and incurred by consumers by facilitating the settlement of valid claims before, or soon after, expensive litigation commences.

Although not limited thereto, the practice of the present invention is particularly advantageous in the early resolution of medical malpractice claims. In such claims, the claimant is usually represented by an attorney specializing in the field, having available experts whom are expected to provide opinions generally more favorable to the claimant than to the carrier. The carrier's claims representative usually is ill-equipped to provide adequate representation for the carrier in the face of such expertise, resulting in the matter being referred to an attorney specializing in the defense of such matters, and also having available experts whom are expected to provide opinions generally more favorable to the carrier than to the claimant. Because neither party places particular weight on the opinions rendered by the other party's experts, settlement of the claim is difficult, with the consequence that many claims which ought to be settled expeditiously are not settled at all, or, if settled, only after significant expenses have been incurred by each of the parties. By the practice of the present invention, a “double blind” and so independent evaluation of the claim is made, to which the parties can reasonably give credence in reaching a settlement acceptable to all concerned early on in the proceedings, rather than later, after significant time and money expenditures have been made.

Generally, a plaintiff suing a physician for negligence or medical malpractice must prove that the physician's conduct deviated from recognized and/or customary medical practice under the particular circumstances (“Standard of Care”). Any treatment inferior to the Standard of Care may give rise to a claim of negligence and/or malpractice. Thus, the typical issue in such medical malpractice claims is whether the care actually rendered to the claimant met an appropriate Standard of Care, referring to the standard of treatment that a “reasonable” physician would provide in the same circumstances. The Standard of Care will vary depending on the patient's condition (for example, there are different standards of care for treating an ulcer and for treating cancer) and will also vary based on geography (rural areas can not be expected to meet the same standards of care as metropolitan areas with major trauma centers, for example). Consequently, in medical malpractice claims, one of the issues in contention often is the definition of the applicable standard of care as to the treatment rendered to the claimant. Any treatment inferior to the standard may give rise to a liability for damages based on a claim of negligence and/or malpractice.

Standard of Care is measured by looking at the level of conduct required under the circumstances. The most common evidentiary test is to ascertain what would a reasonably prudent physician have done (or not done) in treating the patient in this situation. Evidence related to the custom and practice in the profession may also be relevant. However, sometimes custom and practice may lag behind the care that a reasonable and prudent physician currently would provide under the same circumstances as attended the claimant. This lack of an objective standard gives rise to the conventional use of competing expert opinions described above.

Experts in the field often define the standard for care of a specific disease. Medical associations and institutions may also define the standard. A problem may arise when there is a “respectable minority” of local professionals that deviate from the standard to provide a lesser standard of care. In such an instance, the opinion of experts is often sought in ascertaining whether the deviation was acceptable. Factors utilized in attempting to ascertain the standard typically are what would have been done for that condition/disease by a reasonable physician in that community, in similar communities, and nationally.

For some treatments, there are national guidelines in place (currently, for example, see www.guidelines.gov, the National Guideline Clearinghouse (“NGC”)). The NGC is a comprehensive database of “evidence-based” clinical practice guidelines and docs produced by the Agency for Healthcare Research and Quality (“AHRQ”) for the U.S. Dept. of Health and Human Services. The AHRQ currently works with the American Medical Association and the American Association of Health Plans-Health Insurance Association of America to produce such guidelines. In addition to these standards, what is known as a “Gold Standard of Care” exists. A Gold Standard of Care would be the best current method of treatment available anywhere in the world for a particular disease or condition. This can vary significantly from what is common practice and/or acceptable standards of care in any particular geographic area.

By way of example, and not limitation, of the practice of the present invention with respect to the evaluation of a medical malpractice claim, the independent third party, hereinafter referred to as the “claim evaluation provider” is an entity engaged in the business of providing “double blind” medical malpractice claim evaluations to attorneys for claimants and/or insurance carriers and/or the insurance carriers themselves for use by their claims representatives. The claim evaluation provider maintains a listing of medical experts, preferably impartial based on prior experience or reputation, who are willing to provide medical malpractice claim evaluations on an anonymous basis, that is, a double blind basis, in which the identity of the claimant, carrier, and physicians involved is not known to the medical expert, and the identity of the medical expert will not be disclosed to the parties involved in the claim. The claim evaluation provider, after being retained by one or more of the parties (the Retaining Party”) interested in a specific medical malpractice claim (the “Claim”), retains a specific medical expert (the “retained expert”) to make an evaluation of the Claim. The claim evaluation provider provides the retained expert with the objective information resulting from the collection and processing of the collected information by or on behalf of the claim evaluation provider. The claim evaluation provider requires the retained expert to evaluate the claim utilizing the objective information and provide the claim evaluation provider with a written report of the claim evaluation (the “claim evaluation report”) based on the retained expert utilizing the steps illustrated in the following outline:

Step 1

State medical cause of claimant's condition
Include citations from medical literature
State whether there was any action/inaction by the claimant which can be attributed to or cited as the cause of the current condition?

List by symptoms and/or cause

Include citations to medical literature where appropriate

Step 2

State the identity each provider providing treatment to claimant

For each provider,
(a) state each symptom/cause treated by that provider and the treatment to claimant:
(b) state the reasonable standard of care for each symptom/cause treated, including citations from medical literature for the standard of care and
(c) state the gold standard of care for each symptom/cause treated, including citations from medical literature for the standard of care
   Step 3

State the three best arguments why each treatment actually rendered did not meet the applicable standard of care, defining that standard
Provide citations from medical literature for all arguments

State the three best arguments why treatment actually rendered did meet the applicable standard of care
Provide citations from medical literature for all arguments
   Step 4

Without regard for what actually happened with the treatment, describe the treatment you would have selected to be rendered to the claimant, given the claimant's symptom and/or cause
Provide citations from medical literature for treatment you would have selected
Step 5

Assume, for each board-certified physician who rendered care to the claimant in this instance, that the physician's retention of such certification depends on whether the treatment rendered by that physician met the appropriate standard of care for a board-certified physician under these particular circumstances, and, for each such physician:
(a) state each treatment rendered by the physician,
(b) define the standard of care which, in your opinion, is applicable, for such treatment,
(c) for each such standard, state your opinion as to whether the treatment rendered met such standard, and
(d) explain your reasons for each opinion, including citations to medical literature where appropriate.

The retained expert prepares the claim evaluation report and submits it to the claim evaluation provider. The claim evaluation report is processed, as necessary, by the claim evaluation provider to redact all information which would identify the retained expert. The redacted claim evaluation is forwarded to or at the direction of the retaining party for use, as deemed appropriate by the retaining party, in resolving the claim by its use as a double blind evaluation of the claim, that is, a neutral evaluation which can be relied upon by all of the parties as being impartial.

The presently preferred embodiments of the invention has been set forth herein in detail for illustrative purposes only, and it will be apparent to those skilled in the art that variations and modifications thereof, including the rearrangement, addition and/or elimination of steps, lie within the scope of the present invention, which is not limited to the specific sequences of the steps of the specific embodiments illustrated or described herein, but only by the scope of the following claims.

1. A double blind evaluation method for eliminating actual and potential bias from a malpractice claim evaluation process a malpractice claim, comprising the steps of;
retention by an entity having a direct or indirect interest in the claim of a neutral third party to obtain an independent evaluation of the claim;
acquisition by the third party of facts relating to the claim which are sufficient to permit an independent objective evaluation of the claim;
retention by the third party of a qualified independent expert to perform the claim evaluation;
redaction by the third party from the sufficient facts of all facts which would permit the expert to identify any party involved or having an interest in the claim;
submission by the third party of the sufficient facts after redaction to the expert in order to permit the expert to make an independent objective evaluation of the claim;
preparation by the expert of a written independent objective evaluation of the claim;
submission of the written claim evaluation by the expert to the third party;
redaction by the third party from the written claim evaluation of any information which would permit identification the expert; and
submission of the redacted evaluation to the entity retaining the third party.

2. The method of claim 1, and in which the third party, in acquiring facts which are sufficient to permit an independent objective evaluation of the claim, acquires a plurality of the following:
(a) facts and documents that relate to the claim;
(b) background information about the party asserting the claim;
(c) background information about the party against whom the claim is asserted; and
(d) facts about the party's peer group in the same geographic area.

3. The method of claim 2, and in which the background information includes a plurality of the following types of information:
(a) resumes;
(b) at least one curriculum vitae;
(c) educational history;
(d) employment history; and
(e) professional training.

4. The method for generating an independent evaluation by an expert of a medical malpractice claim asserted by a claimant, comprising the expert:
(a) stating medical cause of claimant's condition and including appropriate citations from medical literature;
(b) stating whether there was any action/inaction by the claimant which can be attributed to or cited as the cause of the current condition, listing by symptoms and/or cause;
(c) stating the identity each provider providing treatment to the claimant and, for each provider,
(i) stating each symptom/cause treated by that provider and the treatment rendered to claimant,
(ii) stating the reasonable standard of care for each symptom/cause treated, including citations from medical literature for the standard of care, and either
(A) stating at least one argument why each treatment actually rendered did not meet the applicable standard of care, and providing citations from medical literature for all arguments or
(B) stating at least one argument why each treatment actually rendered did not meet the applicable standard of care, and providing citations from medical literature for all arguments.

5. The method of claim 4, and, with respect to the expert stating the reasonable standard of care for each symptom/cause treated, both
stating at least one argument why each treatment actually rendered did not meet the applicable standard of care, and providing citations from medical literature for all arguments, and
stating at least one argument why each treatment actually rendered did not meet the applicable standard of care, and providing citations from medical literature for all arguments.

6. The method of claim 4, and including the step of the expert stating the treatment that the expert would have selected to be rendered to the claimant, given the claimant's symptom and/or cause and providing citations from medical literature for treatment so selected.

7. The method of claim 5, and including the step of the expert stating the treatment that the expert would have selected to be rendered to the claimant, given the claimant's symptom and/or cause and providing citations from medical literature for treatment so selected.

8. The method of any one of the preceding claims 4 through 7, and including the step of the expert assuming, for at least one board-certified physician who rendered care to the claimant, that the physician's retention of such certification depends on whether the treatment rendered by that physician met the appropriate standard of care for a board-certified physician under these particular circumstances, and stating, for such physician:
(i) a treatment rendered by the physician;
(ii) the definition the standard of care which, in the expert's opinion, is applicable, for such treatment;
(iii) for such standard, whether the treatment rendered met such standard; and
(iv) the expert's reasons for such opinion.
